(19) United States
(12) Patent Application Publication
(10) Pub. No.: US 2011/0096166 A1
(43) Pub. Date: Apr. 28, 2011

(54) TRACTOR TRAILER CAMERA CONTROL SYSTEM AND METHODS OF USE

(76) Inventors: Benjamin ENGLANDER, Woodmere, NY (US); Peter PLATE, Northport, NY (US); Gary BALSAM, Brunswick, NJ (US)

(21) Appl. No.: 12/888,192

(22) Filed: Sep. 22, 2010

Related U.S. Application Data
(60) Provisional application No. 61/244,689, filed on Sep. 22, 2009.

(51) Int. Cl. H04N 7/18

(52) U.S. Cl. 348/148; 348/E07.085

(57) ABSTRACT

A tractor trailer camera control system for relaying a camera video signal through existing tractor and trailer electrical lines without the requirement for a traditional dedicated camera video harness is disclosed. The camera video signal may alternatively be transmitted wirelessly. The camera control system may use relays for powering the various components and controlling the transmission of the camera video signal from the camera to a monitor installed in the cab.

### CROSS-REFERENCE TO RELATED APPLICATIONS

This application claims the benefit under 35 U.S.C. §119(e) of U.S. Provisional Patent Application No. 61/244,689, filed Sep. 22, 2009, which is hereby incorporated by reference herein in its entirety.

### BACKGROUND

Conventional tractor trailer camera systems require a dedicated camera system harness to support the camera system, including the required control structure for providing power to the system. Installing a camera system harness can take hours and result in significant costs. Additionally, the installation can result in penetration holes in and disruption to the tractor trailer body and insulation. Furthermore, when the tractor portion of the vehicle is disconnected from the trailer, an additional step is required to disconnect the dedicated camera system harness.

Accordingly, it would be desirable to provide a tractor trailer camera control system and methods of use, and in particular, a tractor trailer camera control system that provides power to the camera without installing a dedicated camera system harness.

### SUMMARY

A tractor trailer camera control system and methods of use are provided. The tractor trailer camera control system of the disclosed subject matter permits the power supply signal for the camera to be relayed through existing tractor and trailer electrical lines. The camera video signal may be relayed through existing tractor and trailer electrical lines or may be wirelessly transmitted to a receiver, for example. By using existing tractor and trailer electrical lines, the tractor trailer camera control system does not require a traditional dedicated harness.

In accordance with the disclosed subject matter, a camera control system for a tractor and a trailer is provided. The camera control system may comprise a camera that provides a video signal and is configured for mounting on the trailer. The camera control system may further comprise a transmitter configured for coupling to the camera to transmit the video signal, a control relay comprising a first terminal configured for coupling to head lights of the tractor, the control relay configured for supplying power to the head lights through the first terminal. The control relay of the camera control system may be further configured for supplying power to the transmitter through a second terminal of the control relay when power is supplied to the head lights.

In some embodiments of the disclosed subject matter, a camera control system for a tractor and a trailer is provided. The camera control system may comprise a camera that provides a video signal and is configured for mounting on the trailer. The camera control system may further comprise a transmitter configured for coupling to the camera to transmit the video signal, a control relay comprising a first terminal configured for coupling to head lights of the tractor, the control relay configured for supplying power to the head lights through the first terminal. The control relay of the camera control system may be further configured for supplying power to the transmitter through a second terminal of the control relay when the tractor is in reverse gear.

In some embodiments of the disclosed subject matter, a camera control system for a tractor and a trailer is provided. The camera control system may comprise a camera that provides a video signal and is configured for mounting on the trailer. The camera control system may further comprise a transmitter configured for coupling to the camera to transmit the video signal, a control relay comprising a first terminal configured for coupling to head lights of the tractor, the control relay configured for supplying power to the head lights through the first terminal. The camera control system may further comprise a monitor configured for displaying the video signal. The control relay of the camera control system may be further configured for supplying power to the transmitter through a second terminal of the control relay when an override switch is turned on or the monitor is turned on.

### BRIEF DESCRIPTION OF THE DRAWINGS

FIG. 1 is a schematic diagram of an illustrative implementation of the tractor trailer camera control system according to aspects of the disclosed subject matter.

### DETAILED DESCRIPTION

The tractor trailer camera control system of the disclosed subject matter permits the power supply signal for the camera to be relayed through existing tractor and trailer electrical lines. The camera control system has specific application and value in cases where trailers require detachment from tractors and where tractors and trailers are not dedicated to each other and may very well be mixed and matched with other equipment. The disclosed camera control system provides a user with the ability to disconnect a tractor from a trailer without the added step of disconnecting a dedicated camera harness. Therefore, the owner of a fleet of tractors and trailers that have installed the disclosed camera system can benefit by being able to connect any tractor with any trailer without having to disconnect the harness. Removing the need for a dedicated camera harness reduces the installation hours and cost of a camera system installation. The disclosed tractor trailer camera control system preserves the integrity of a trailer by minimizing penetration holes and disruption to the trailer body and insulation.

In some embodiments, the camera control system uses relay control logic, electrical connectors and conductors to power a camera installed at the trailer. The disclosed subject matter provides systems and methods for powering the camera where the powering of the camera may be triggered automatically or manually by driver action. For example, relaying power to the camera may be triggered automatically when the headlights are on. Alternatively, relaying power to the camera may be triggered automatically when the tractor is in reverse gear, even when the headlights are off. Alternatively, relaying power to the camera may be triggered when the driver turns on a monitor installed in the cab of the tractor or when the driver turns on an override switch located in the cab of the tractor.

In some embodiments, the camera control system uses relay control logic, in conjunction with video signal transmitters, receivers, and a monitor, to display on the monitor the video signal from a camera installed at the trailer. The monitor may be, for example, installed in the cab of the vehicle.

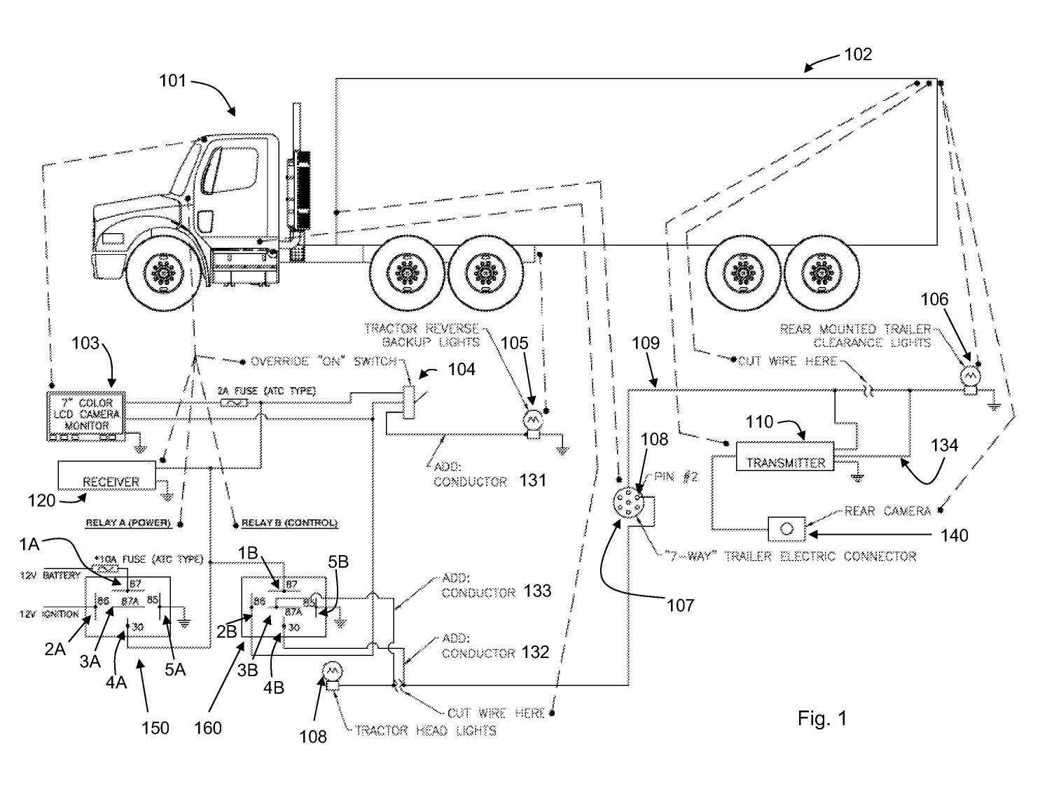

FIG. 1 is a schematic diagram of an illustrative implementation of the tractor trailer camera control system according to aspects of the disclosed subject matter. FIG. 1 shows a conventional tractor 101 and a trailer 102. Tractor 101 has tractor reverse backup lights 105 and trailer 102 has rear mounted trailer clearance lights 106. A rear view camera 140 and a transmitter 110 coupled to the camera 140 are installed near the rear mounted trailer clearance lights 106. A monitor 103 may be installed inside the cab in a position where it is visible by the driver. Monitor 103 may be, for example, a 7″ color LCD camera monitor. This example is merely illustrative, and any suitable monitor may be used. Inside the cab of the vehicle may also be installed a receiver 120 for receiving the camera video signal transmitted by transmitter 110. The control logic of the camera control system may include a power relay 150, a control relay 160, and an override “ON” switch. The control logic may be installed, for example, in the dashboard of tractor 101. The camera control system may use a 7-way connector (commonly referred to in the industry as a “Suzie Connector”) or any other suitable connector, normally installed in conventional tractor and trailer coupling, for providing electrical connectivity between the components of the camera system installed on the tractor and components installed on the trailer.

Power relay 150 routes the power to different camera control system components. Terminal 1A may be coupled through a fuse to a battery supply, for example, a 12V battery supply, and terminal 1B may be coupled to the ignition supply. Terminal 4A may be coupled to receiver 120 and monitor 103, providing power to those components. Additionally, terminal 4A may be coupled to control relay 160 terminal 1B for providing power to the components connected to relay 160.

Terminal 2B of control relay 160 may be coupled to override switch 104 which in turn is connected to tractor reverse backup lights 105 through conductor 131. Terminal 3B may be coupled to the tractor headlight circuit through conductor 133. Terminal 4B may be coupled to a pin of the 7-way connector, for example, pin #2. In alternative embodiments, tractor headlights 108 may be powered directly by a power source. In such embodiments, there is no cut of the wire that normally connects the tractor headlights with its normal power source.

In some embodiments, relaying power to the camera may be triggered automatically when tractor headlights 108 are on. For example, when headlights 108 are on, relay 160 supplies power to transmitter 110 through terminal 30 and electrical connector 107. When transmitter 110 is powered, power is routed to camera 140 and trailer clearance lights 106.

Alternatively, the control logic included in the camera control system of the disclosed subject matter may be triggered to power the camera when the tractor headlights are off and the tractor is in reverse gear.

In some embodiments, the camera system may be activated by manual driver intervention. Specifically, when the tractor headlights are off, the control logic may direct power to the camera system when a driver of the tractor turns on the camera monitor 103 or selects an override “On” switch installed in the cab of the tractor (e.g., “On” switch 104). This example is merely illustrative, and the camera may be powered when the headlights are off in any other suitable manner.

A power wire for the rear (high mounted) clearance lights may automatically allow “back feed” power to the camera when power in the clearance light circuit is not normally available. This can happen, for example, when the headlights to the tractor are off, which can also control the clearance lights of the trailer and render them off as well. When the clearance lights are off, the camera may have no local power source. Existing conventional installations have no ability to automatically deliver power to a rear mounted camera. These manually-operated installations are not fail safe, but rather, are dependent on driver inclination, awareness, and willingness to use them.

In accordance with one aspect of the disclosed subject matter, the camera video image may not be displayed in the cab monitor unless any of the above triggering scenarios are present.

In some embodiments, when the camera is on, the camera video signal may be transmitted through power wire 109 which delivers power to the rear clearance lights. The transmitter 110 when activated receives the video signal from the camera 140 and formats the video signal for transmission. The video signal may be formatted for transmission through connector 107 or wirelessly, for example. Receiver 120 receives the signal and delivers it to monitor 103. Receiver 120 may receive the video signal through relay 160, when the signal is transmitted through connector 107. Alternatively, receiver 120 may wirelessly receive the video signal.

As discussed above, relay 160 terminal 4B supplies power to a pin of connector 107, for example pin #2, but also receives the camera video signal in the reverse direction from pin #2 (e.g., from the transmitter 110 to the receiver 120). For example, the camera video signal may be overlaid on the power signal. The camera video signal is received at receiver 120 through relay 160. For example, as shown in FIG. 1, the video signal is received at receiver 120 through terminal 1B. Receiver 120 interprets the video signal format and outputs the video signal to camera monitor 103. Alternatively, the camera video signal can be transmitted to the receiver wirelessly.

The camera video signal may be transmitted even if the monitor 103 is turned off. For example, the video image may be available and waiting at the output of the receiver 120 for the monitor to use it. In some embodiments, the camera may be powered by using different conductors or existing tractor and trailer wiring besides the clearance light power wire 109.

In some embodiments, the camera control logic implements control relay 160 to help isolate the functions of the tractor from the process of powering camera 140 to prevent unwanted powering of the components normally on the same circuit as the rear clearance lights 140, such as tractor headlights 108. Alternatively, the camera control logic may implement two relays to help isolate the functions of the tractor from the process of powering camera 140. For example, the control logic, via the use of two relays and a pin on a 7-way connector, may back feed power to the camera while at the same time preventing powering the equipment on the tractor which shares the same circuit connected to the 7-way connector pin and the clearance lights. Examples of tractor equipment to be isolated from this power back feeding may include, for example, the tractor headlights and clearance lights.

In some embodiments, the relay control logic may isolate functions of the 7-way connector associated with the tractor 101, while simultaneously powering all equipment on the trailer 102 which is connected to the same pin of the 7-way connector. Alternatively, other pins and/or conductors of the 7-way connector or other connectors may be used. In addition, the disclosed camera control system can be used with different types of connectors used to electrically connect the cab and the tractor trailer.

The camera control system described above may accomplish several alternative and/or simultaneous tasks in various embodiments. For example, the camera control system may power the trailer camera and transmitter while the override switch is at the “on” position. In another example, the camera control system may power the trailer camera and transmitter during reverse operations of the tractor. In yet another example, the camera control system may automatically turn the monitor and receiver on while the override switch is at the “on” position. In still another example, the camera control system may automatically turn the monitor and receiver on during reverse operations of the tractor. In yet another example, the camera control system may allow for a normal headlight on switch position in the tractor to power pin #2 on the 7-way connector, and hence the rear clearance lights and camera system. In still another example, the camera control system may allow for the headlights and headlight circuit to remain off in the tractor for some embodiments of the invention when the trailer camera and transmitter is powered (isolate the tractor).

As provided in FIG. 1, relays 150 and 160 may be any standard relay as configured in the combination of the present invention. For example, relays 150 and 160 may be a Bosch/Tyco relay, Part No. 0332209150. Any other standard relay may be used. In addition, the transmitter and receiver may be standard components. For example, the Video Over Cable System transmitter and receiver components provided by Neotech Photoelectric Inc. may be used. The Video Over Cable System has the following specifications:

| Model | | Model | |
|---|---|---|---|
| Number | Video Transmitter | Number | Video Receiver |
| Video Output | 1.0 Vp-p, 75 Ohm | Video Input | 1.0 Vp-p, 75 Ohm |
| Power Input | DC 12 V~24 V | Power Input | DC 12 V~24 V |
| Power Output | DC 12 V or DC 24 V | Power Output | DC 12 V or DC 24 V |
| Rear Gear | DC + 12 V | Power | Max 50 mA |
| Trigger | | Consumption | |
| Power | Max 50 mA | Operating Temp | −10° C.~+70° C. |
| Consumption | | | |
| Dimension(mm) | 137(W) × 65(H) × 20(D) | Dimension(mm) | 137(W) × 65(H) × 20(D) |
| Weight(N.W) | 110 g | Weight(N.W) | 110 g |

As an alternative to the Video Over Cable system, the commercially available PLC-1000 Remote Signal System provided by Brigade Electronics, PLC, Station Road, South Darenth, Kent, UK may be used for the receiver and transmitter components. The specifications of the PLC-1000 include the following details: Transmitter/Receiver; Video input/output 1.0Vp-p, 75; Power input 12-24Vdc; Power output 12Vdc; Power consumption 80 mA @ 24Vdc; Operating temperature −20° C. to +60° C.; Weight 290 g˜250 g; Size (mm) (w×h×d) 160×65×25; Waterproof IP67(transmitter); Continues load current: 3A @ 24V; and Peak load current: 5A @ 24V.

Alternatively, the system as described in U.S. Pat. No. 4,815,106 entitled Power Line Communication Apparatus may be used, the contents of which are hereby incorporated by reference herein in their entirety.

It will be understood that the foregoing is only illustrative of the principles of the invention, and that various modifications can be made by those skilled in the art without departing from the scope and spirit of the invention.

What is claimed is:

1. A camera control system for a tractor and a trailer comprising:
a camera that provides a video signal and configured for mounting on the trailer;
a transmitter configured for coupling to the camera to transmit the video signal; and
a control relay comprising a first terminal configured for coupling to head lights of the tractor, the control relay configured for supplying power to the head lights through the first terminal;
wherein the control relay is further configured for supplying power to the transmitter through a second terminal of the control relay when power is supplied to the head lights.

2. The camera control system of claim 1, further comprising an electric connector configured to couple the transmitter to the second terminal.

3. The camera control system of claim 1, further comprising a power relay configured for coupling a power source to a third terminal of the control relay.

4. The camera control system of claim 1, further comprising:
a receiver configured for receiving the video signal through the control relay; and
a monitor configured for coupling to the receiver to display the video signal.

5. The camera control system of claim 1, further comprising:
a receiver configured for wirelessly receiving the video signal; and
a monitor configured for coupling to the receiver to display the video signal.

6. The camera control system of claim 1, wherein the transmitter is configured for supplying power to the camera and clearance lights of the trailer.

7. A camera control system for a tractor and a trailer comprising:
a camera that provides a video signal and configured for mounting on the trailer;
a transmitter configured for coupling to the camera to transmit the video signal; and
a control relay comprising a first terminal configured for coupling to head lights of the tractor, the control relay configured for supplying power to the head lights through the first terminal;
wherein the control relay is further configured for supplying power to the transmitter through a second terminal of the control relay when the tractor is in reverse gear.

8. The camera control system of claim 7, wherein the control relay is further configured for supplying power to the transmitter through the second terminal when power is not supplied to the head lights.

9. The camera control system of claim 7, further comprising an electric connector configured for coupling the transmitter to the second terminal.

10. The camera control system of claim 7, further comprising a power relay configured for coupling a power source to a third terminal of the control relay.

11. The camera control system of claim 7, further comprising:
a receiver configured for receiving the video signal through the control relay; and
a monitor configured for coupling to the receiver to display the video signal.

12. The camera control system of claim 7, further comprising:
a receiver configured for wirelessly receiving the video signal; and
a monitor configured for coupling to the receiver to display the video signal.

13. The camera control system of claim 7, wherein the transmitter is configured for supplying power to the camera and to clearance lights of the trailer.

14. A camera control system for a tractor and a trailer comprising:
a camera that provides a video signal and configured for mounting on the trailer;
a transmitter configured for coupling to the camera to transmit the video signal;
a control relay comprising a first terminal configured for coupling to head lights of the tractor, the control relay configured for supplying power to the head lights through the first terminal; and
a monitor configured for displaying the video signal;
wherein the control relay is further configured for supplying power to the transmitter through a second terminal of the control relay when an override switch is turned on or the monitor is turned on.

15. The camera control system of claim 14, wherein the control relay is further configured for supplying power to the transmitter through the second terminal when power is not supplied to the head lights.

16. The camera control system of claim 14, further comprising an electric connector configured for coupling the transmitter to the second terminal.

17. The camera control system of claim 14, further comprising a power relay configured for coupling a power source to a third terminal of the control relay.

18. The camera control system of claim 14, further comprising a receiver configured for coupling to the monitor to receive the video signal through the control relay.

19. The camera control system of claim 14, further comprising a receiver configured for coupling to the monitor to wirelessly receive the video signal.

20. The camera control system of claim 14, wherein the transmitter is configured for supplying power to the camera and to clearance lights of the trailer.
